(19) United States
(12) Patent Application Publication
(10) Pub. No.: US 2026/0254985 A1
(43) Pub. Date: Aug. 27, 2026

(54) IMPLICIT ENCODING OF A MESH TOPOLOGY

(71) Applicant: InterDigital CE Patent Holdings, SAS, Paris (FR)

(72) Inventors: Jean-Eudes MARVIE, PLERIN (FR); Maja KRIVOKUCA, Cesson-Sevigne (FR); Olivier MOCQUARD, Cesson-Sevigne (FR); Julien RICARD, Plouër-sur-Rance (FR)

(21) Appl. No.: 18/877,996

(22) PCT Filed: Jun. 21, 2023
(86) PCT No.: PCT/EP2023/066836

§ 371 Date: Dec. 20, 2024

(30) Foreign Application Priority Data
Jul. 7, 2022 (EP) 22306020.3

(51) Int. Cl. H04N 19/46

(52) U.S. Cl. CPC H04N 19/46

(57) ABSTRACT

Apparatuses and methods are disclosed for encoding a mesh topology. Techniques disclosed include generating a vertex chain data record, containing information representative of a topology of mesh patches that constitute partitions of a given mesh. The techniques further include encoding the generated vertex chain data record into a vertex chain symbol stream and then encoding the vertex chain symbol stream into a coded mesh. Additionally, apparatuses and methods are disclosed for reconstructing the mesh topology. Techniques disclosed include decoding the coded mesh into a decoded vertex chain symbol stream and then decoding the decoded vertex chain symbol stream into a decoded vertex chain data record. Based on the decoded vertex chain data record, the given mesh is reconstructed.

### BACKGROUND

Meshes are commonly used to represent surfaces of objects featured in computer generated video or in video enhanced by augmented reality. Such surface representations have to be compressed to allow for efficient streaming or storage. Processes for compressing meshes may be costly as mesh topologies of dynamic and expressive objects can be spatially complex. In some application domains, such as entertainment, lossy compression of mesh topologies may not compromise the user experience as sufficiently high perceptive quality may be maintained. In such domains, efficient techniques for lossy encoding of complex and dynamic mesh topologies are needed.

### SUMMARY

Aspects disclosed in the present disclosure describe methods for encoding a mesh topology. The methods comprise generating a vertex chain data record, containing information representative of a topology of mesh patches that constitute partitions of a mesh. Then, encoding the generated vertex chain data record into a vertex chain symbol stream, and further encoding the vertex chain symbol stream into a coded mesh. Aspects disclosed herein also describe methods for reconstructing a mesh topology. The methods comprise decoding a coded mesh into a decoded vertex chain symbol stream, and further decoding the decoded vertex chain symbol stream into a decoded vertex chain data record, containing information representative of a topology of mesh patches that constitute partitions of a mesh. Then, reconstructing the mesh based on the decoded vertex chain data record.

Aspects disclosed in the present disclosure describe apparatuses for encoding a mesh topology. The apparatuses comprise at least one processor and memory storing instructions. The instructions, when executed by the at least one processor, cause the systems: to generate a vertex chain data record, containing information representative of a topology of mesh patches that constitute partitions of a mesh; to encode the generated vertex chain data record into a vertex chain symbol stream; and to encode the vertex chain symbol stream into a coded mesh. Aspects disclosed herein also describe apparatuses for reconstructing a mesh topology. The apparatuses comprise at least one processor and memory storing instructions. The instructions, when executed by the at least one processor, cause the systems: to decode a coded mesh into a decoded vertex chain symbol stream; to decode the decoded vertex chain symbol stream into a decoded vertex chain data record, containing information representative of a topology of mesh patches that constitute partitions of a mesh; and to reconstruct the mesh based on the decoded vertex chain data record.

Aspects disclosed in the present disclosure describe a non-transitory computer-readable medium comprising instructions executable by at least one processor to perform a method for encoding a mesh topology. The methods comprise generating a vertex chain data record, containing information representative of a topology of mesh patches that constitute partitions of a mesh. Then, encoding the generated vertex chain data record into a vertex chain symbol stream, and further encoding the vertex chain symbol stream into a coded mesh. Aspects disclosed herein also describe a non-transitory computer-readable medium comprising instructions executable by at least one processor to perform a method for reconstructing a mesh topology. The methods comprise decoding a coded mesh into a decoded vertex chain symbol stream, and further decoding the decoded vertex chain symbol stream into a decoded vertex chain data record, containing information representative of a topology of mesh patches that constitute partitions of a mesh. Then, reconstructing the mesh based on the decoded vertex chain data record.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

FIG. 1 illustrates an example mesh patch, according to an aspect of the present disclosure.

FIG. 2 is a functional block diagram of an example mesh topology encoder, according to an aspect of the present disclosure.

FIG. 3 is a functional block diagram of an example mesh topology decoder, according to an aspect of the present disclosure.

FIG. 4 illustrates an example mesh patch, including vertex chains, according to an aspect of the present disclosure.

FIG. 5 illustrates a construction of an example vertex chain data record, according to an aspect of the present disclosure.

FIG. 6 illustrates a reconstruction of an example mesh patch topology using a nearest point approach, according to an aspect of the present disclosure.

FIG. 7 illustrates a reconstruction of an example mesh patch topology using a triangle strip approach, according to an aspect of the present disclosure.

FIG. 8 is a flow diagram of an example method for encoding a mesh topology, according to an aspect of the present disclosure.

FIG. 9 is a flow diagram of an example method for reconstructing a mesh topology, according to an aspect of the present disclosure.

### DETAILED DESCRIPTION

Apparatuses and methods are disclosed, including techniques for lossy compression of a mesh topology. According to aspects described herein, to reduce the complexity and increase the compression rate, a given mesh with a general topology is partitioned into mesh patches with simpler topologies, each of which may be encoded separately. The encoded mesh patches may then be decoded and combined to reconstruct the full mesh topology. Hence, aspects of the lossy compression disclosed herein may result in a reconstructed mesh surface that may be perceptively the same as the given mesh surface, providing a good tradeoff between perceptive video quality and compression rate.

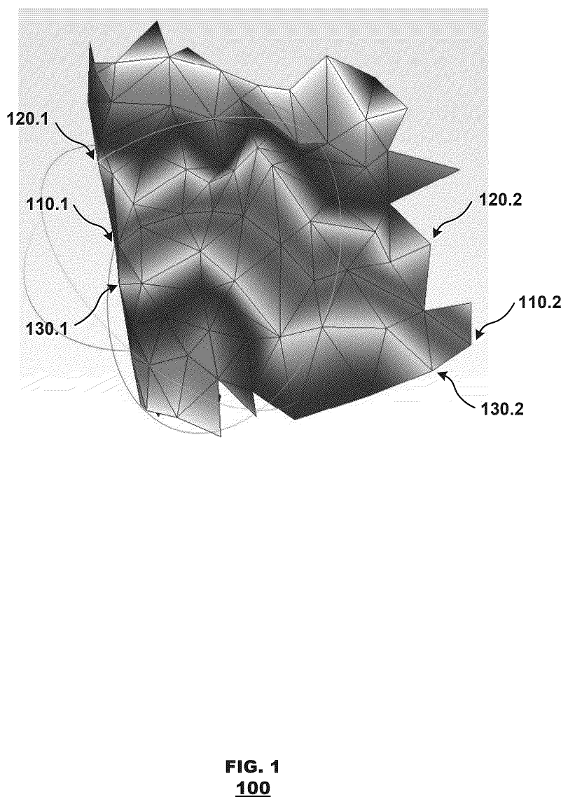

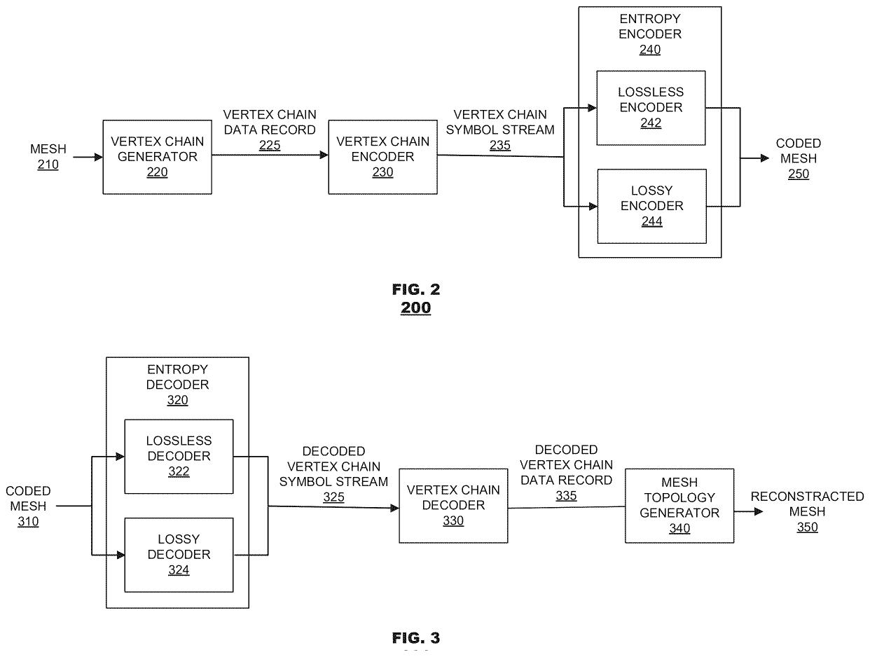

FIG. 1 illustrates an example mesh patch 100, according to an aspect of the present disclosure. A given mesh with a general topology may be partitioned into mesh patches (e.g., the mesh patch 100 of FIG. 1) that are each homeomorphic to a disk—that is, a mesh whose entire three-dimensional (3D) shape can be unfolded into a single two-dimensional (2D) surface, so that the mesh's triangles do not intersect or overlap with each other (see, S. Shlafman, et al., Metamorphosis of Polyhedral Surfaces using Decomposition, Eurographics, Volume 21 (2002), Number 3, 2002). A mesh patch 100, typically, consists of vertices connected by triangles. The surfaces of the triangles, from all the mesh patches of a mesh topology, approximate a 3D (or a 2D) surface. Techniques disclosed herein, represent (encode) mesh patches of a mesh with a general topology. To that end, the topology of each mesh patch may be analyzed to derive vertex chains—that is, chains of vertices that extend, for example, from boundary vertices 110.1, 120.1, and 130.1 to boundary vertices 110.2, 120.2, and 130.2, respectively. The derived vertex chains, from all the mesh patches, may then be recorded into a vertex chain data record, the data of which are encoded in a vertex chain symbol stream. The vertex chain symbol stream may be further encoded, employing lossless and/or lossy compression techniques. The encoding and decoding of a mesh topology is further described in reference to FIG. 2 and FIG. 3.

FIG. 2 is a functional block diagram of an example mesh topology encoder 200, according to an aspect of the present disclosure. The mesh topology encoder 200 may include a vertex chain generator 220, a vertex chain encoder 230, and an entropy encoder 240. The components 220, 230, 240 of the mesh topology encoder 200 may be implemented by software, firmware, and/or hardware. Further, these components 220, 230, 240 may be implemented by computational units that are local to each other or by computational units that are remote from each other and are communicatively connected by wireless or wired communication technologies. The vertex chain generator 220 may be configured to receive a mesh 210 and to generate a vertex chain data record 225 out of the received mesh topology. The generated vertex chain data record 225 may then be fed into the vertex chain encoder 230. The vertex chain encoder 230 may be configured to encode the vertex chain data record into a vertex chain symbol stream 235. The vertex chain symbol stream 235 may then be fed into the entropy encoder 240 that may encode the received stream into a coded mesh 250. Accordingly, portions of the stream 235 that represent structural data may be encoded by a lossless encoder 242 while portions of the stream that represent positional data (of the mesh vertices) may be encoded by a lossy encoder 244. A mesh topology decoder, generally, reverses the operation of the mesh topology encoder 200, decoding the coded mesh 250 into a reconstructed mesh topology, as further described below.

FIG. 3 is a functional block diagram of an example mesh topology decoder 300, according to an aspect of the present disclosure. The mesh topology decoder 300 may include an entropy decoder 320, a vertex chain decoder 330, and a mesh topology generator 340. The components 320, 330, 340 of the mesh topology decoder 300 may be implemented by software, firmware, and/or hardware. Further, the decoder's components 320, 330, 340 (as well as the encoder's components 220, 230, 240) may be implemented by computational units that are local to each other or by computational units that are remote from each other and are communicatively connected by wireless or wired communication technologies. The entropy decoder 320 may receive the coded mesh 250, 310, and may decode therefrom, either by a lossless decoder 322 or a lossy decoder 324, a decoded vertex chain symbol stream 325. The vertex chain decoder 330 may receive the decoded vertex chain symbol stream 325 and may decode therefrom the vertex chain data record. The decoded vertex chain data record 335 may then be used by the mesh topology generator 340 to reconstruct the mesh 350. Further description of the operations of the mesh topology encoder 200 and the mesh topology decoder 300 is provided below.

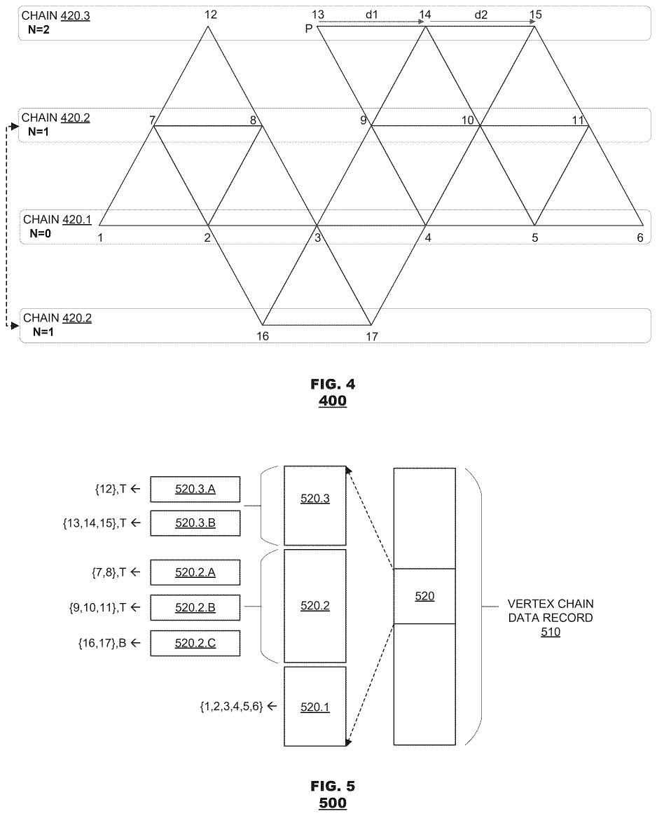

In an aspect, the vertex chain generator 220 of the mesh topology encoder 200 may receive a mesh of a general topology 210 and may partition the given mesh topology into mesh patches that are each homeomorphic to a disk, for example the patch 100 that is illustrated in FIG. 1. The vertex chain generator 220 may then derive vertex chains from each of the mesh patches and may represent the patches' vertex chains in a vertex chain data record. The process of deriving vertex chains out of mesh patches and generating a vertex chain data record is described in reference to FIG. 4 and FIG. 5, respectively.

FIG. 4 illustrates an example mesh patch 400, including vertex chains, according to an aspect of the present disclosure. A vertex chain is defined herein as a path through vertices of the mesh patch 400 that may extend from one boundary vertex to another boundary vertex. Deriving vertex chains, as performed by the vertex chain generator 220, may be carried out in two steps. In the first step, a reference vertex chain may be determined. Then, in the second step, additional vertex chains may be determined relative to that reference vertex chain. Determining the reference vertex chain may involve searching for the longest direct path that links two vertices on the mesh's boundary. For example, a reference vertex chain is demonstrated by the path between boundary vertices 110.1 and 110.2 of FIG. 1. Other vertex chains may be determined relative to that reference vertex chain, such as the vertex chains that link boundary vertices 120.1 and 130.1 to boundary vertices 120.2 and 130.2, respectively.

To determine the reference vertex chain of a mesh patch 400, in an aspect, the spatial positions of vertices of the mesh patch 400 are analyzed. Thus, going through the vertices of one patch, the boundary vertices are first determined. For example, the boundary vertices 1, 6, 7, 11, 12, 15, 16, and 17 can be determined out of all vertices 1-17 of the mesh patch 400, as shown in FIG. 4. Then, for each boundary vertex, the shortest path is computed between the boundary vertex and the other boundary vertices. Computing the shortest paths between pairs of boundary vertices can be done, for example, by employing a Dijkstra algorithm. The pair of vertices for which the computed path is the longest may be selected as the reference vertex chain. For example, the path through vertices {1, 2, 3, 4, 5, 6} forms the reference vertex chain 420.1 of the mesh path 400 shown in FIG. 4.

Once the reference vertex chain 420.1 is determined, other vertex chains 420.2-420.3 of the mesh patch 400 may be derived relative to the reference vertex chain 420.1. To that end, starting from the reference vertex chain 420.1, the vertices that are separated by N=1 number of mesh edges from a respective closest vertex from the reference vertex chain may be found—that is, vertices 7-11 and 16-17 in the example mesh patch 400 of FIG. 4. Such vertices may form one or more chains 420.2, referred to herein as chains at a level N=1—that is, relative to the reference vertex chain 420.1 that is referred to herein as a chain at a level N=0. As demonstrated in FIG. 4, there are three vertex chains 420.2 at level N=1: chain {7, 8} and chain {9, 10, 11} that are located above the reference vertex chain 420.1 and chain {16, 17} that is located below the reference vertex chain 420.1. Next, the vertices that are separated by N=2 number of mesh edges from a respective closest vertex from the reference vertex chain may be found—that is, vertices 12-15 in the example mesh patch 400 of FIG. 4. Such vertices may form one or more chains 420.3 at level N=2. As demonstrated in FIG. 4, there are two vertex chains 420.3 at level N=2: chains {12} and {13, 14, 15} that are both located above the reference vertex chain 420.1. Information associated with the derived vertex chains may be recorded in a vertex chain data record, as described next in reference to FIG. 5.

FIG. 5 illustrates a construction of an example vertex chain data record 500, according to an aspect of the present disclosure. The vertex chain data record 510 may contain information associated with vertex chains, derived from the mesh patches, each of which constitutes a partition of a given mesh 210. The vertex chain data record 510 may be composed of patch records, each of which corresponds to one mesh patch (e.g., patch record 520 corresponds to patch 400). A patch record 520 may contain data segments 520.1-3 that record information associated with respective vertex chains. The segments 520.1-3 may be arranged in increasing order according to the level N of the respective vertex chains. Thus, a data segment (e.g., 520.1, 520.2, or 520.3) may record references to the vertices of vertex chains at a certain level Nin a consecutive order. Data segments that correspond to vertex chains other than the reference vertex chain (e.g., 520.2 or 520.3) may also record a chain's relative position to the reference vertex chain-encoding a chain that is situated above the reference vertex chain by “T′” (i.e., top chain) and encoding a chain that is situated below the reference vertex chain by “B” (i.e., bottom chain).

For example, information associated with the reference vertex chain 420.1 may be recorded in data segment 520.1, including an ordered list of the vertices in that chain—that is, {1, 2, 3, 4, 5, 6}. Information associated with vertex chains 420.2 may be recorded in segment 520.2, including information associated with the three chains that may be recorded in respective sub-segments 520.2A-C. Thus, as illustrated in FIG. 5, a sub-segment 520.2.A may record information associated with chain {7, 8}, including a relative position indicator “T” (to indicate the chain's position being above the reference vertex chain), a sub-segment 520.2.B may record information associated with chain {9, 10, 11}, including a relative position indicator “T” (to indicate the chain's position being above the reference vertex chain), and a sub-segment 520.2.C may record information associated with chain {16, 17}, including a relative position indicator “B” (to indicate the chain's position being below the reference vertex chain). Likewise, information associated with vertex chains 420.3 is recorded in segment 520.3, including information associated with the two chains that is recorded in respective sub-segments 520.3A-B. Thus, as illustrated in FIG. 5, a sub-segment 520.3.A may record information associated with chain {12}, including a relative position indicator “T” (to indicate the chain's position being above the reference vertex chain) and a sub-segment 520.3.B may record information associated with chain {13, 14, 15}, including a relative position indicator “T” (to indicate the chain position being above the reference vertex chain).

Hence, the vertex chain data record 510 contains both positional information (of vertices contained in the vertex chains) and implicit structural information. The structural information represents the mesh's topology by virtue of the ordering of the vertices in the record 510 according to their chain association. For example, in the case illustrated in FIG. 5, the ordering in which data are stored in the patch record 520 of the vertex chain data record 510 is {1, 2, 3, 4, 5, 6}, {7, 8}, T, {9, 10, 11}, T, {16, 17}, B, {12}, T, {13, 14, 15}, T.

Once constructed, by the vertex chain generator 220, the vertex chain data record 510 may be provided to the vertex chain encoder 230. The vertex chain encoder 230 may encode the obtained record 510 into a vertex chain symbol stream. As mentioned above, the vertex chain generator 220 may generate multiple patch records 520, respective of the multiple patches that form the input mesh 210—and so, the vertex chain symbol stream, generated by the vertex chain encoder 230, encodes all these records.

Hence, according to aspects, the vertex chain encoder 230 may be configured to signal data elements of the vertex chain data record 510 by respective symbols. For example, data elements that represent the number of patches, the number of vertex chains in a patch, and the number of vertices in a vertex chain may be represented, independently or relative to each other, in various orders, by respective symbols. Likewise, data elements that represent the level N associated with a vertex chain and the relative position of the chain to the reference vertex chain, may be represented independently or relative to each other, in various orders, by respective symbols. Furthermore, data elements that represent positional data of vertices in a vertex chain may be represented independently or relative to each other, in various orders, by respective symbols. In an aspect, the vertex chain encoder 230 may be configured to signal data elements of the vertex chain data record 510 by respective symbols as demonstrated by Table 1, Table 2, or Table 3.

Table 1 illustrates vertex chain symbol stream signaling in the case where the coordinates of vertices in the vertex chains are coded by their global spatial locations.

TABLE 1
vertex chain symbol stream signaling, using global coordinates

| | | |
|---|---|---|
| Nb_Patches | N_{patches} - Number of patches to | P bits |
| | encode | |
| Nb_chains | An array of size N_{patches}, containing | M bits per entry, with M |
| | integer values, each representing | being the number of bits |
| | the number of vertex chains per | needed to encode the largest |
| | patch. | number of chains of any of |
| | | the N_{patches} patches. |
| Nb_vert | An array, containing integer values | K bits per vertex chain, with |
| | that each represents the length of a | K being the number of bits |
| | respective vertex chain. | needed to encode the largest |
| | | length value of a chain of |
| | | any of the N_{patches} patches. |
| Depth_change | An array of binary flags, where “1” | 1 bit per vertex chain, |
| | indicates the event of a change in | except for the first chain of |
| | the depth level (i.e., N) and “0” | each patch (that is, the |
| | indicates the event of no change in | reference vertex chain). |
| | the depth level. | |
| Relative_Position | An array of binary flags that each | 1 bit per vertex chain, |
| | indicates whether a respective | except for the first chain of |
| | vertex chain is above or below the | each patch. |
| | respective reference vertex chain. | |
| Vertex_Positions | An array of vertex coordinates | Qₚ bits per vertex position |
| | (x, y, z) for a 3D mesh or (x, y) for | component times the total |
| | a 2D mesh), concatenated in order. | number of vertices from |
| | | vertex chains of all the |
| | | N_{patches} patches. |

Table 2 illustrates the signaling of the vertex chain symbol stream in the case where coordinates of the vertex chains are coded by their relative spatial locations (delta coordinates). That is, a coordinate of each vertex in a chain is coded relative to the coordinate of the previous vertex, except for the first vertex's coordinate in a chain that is coded by its global spatial location. In this case, for example in vertex chain {13, 14, 15} of FIG. 4, the location of vertex 15 may be encoded relative to vertex 14 (the delta value denoted by d₂) and the location of vertex 14 may be encoded relative to vertex 13 (the delta value denoted by d₁), while the location of vertex 13 may be encoded by its global coordinate (denoted by P). In this manner, a better compression rate may be achieved.

TABLE 2
vertex chain symbol stream signaling, using delta coordinates.

| | | |
|---|---|---|
| Nb_Patches | N_{patches} - Number of patches to | P bits |
| | encode | |
| Nb_chains | An array of size N_{patches}, containing | M bits per entry, with M |
| | integer values, each representing | being the number of bits |
| | the number of vertex chains per | needed to encode the largest |
| | patch. | number of chains of any of |
| | | the N_{patches} patches. |
| Nb_vert | An array, containing integer values | K bits per vertex chain, with |
| | that each represents the length of a | K being the number of bits |
| | respective vertex chain. | needed to encode the largest |
| | | length value of a chain of |
| | | any of the N_{patches} patches. |
| Depth_change | An array of binary flags, where “1” | 1 bit per vertex chain, |
| | indicates the event of a change in | except for the first chain of |
| | the depth level (i.e., N) and “0” | each patch (that is, the |
| | indicates the event of no change in | reference vertex chain). |
| | the depth level. | |
| Relative_Position | An array of binary flags that each | 1 bit per vertex chain, |
| | indicates whether a respective | except for the first chain of |
| | vertex chain is above or below the | each patch. |
| | respective reference vertex chain. | |
| Vertex_Positions | An array of vertex coordinates | Qₚ bits per vertex position |
| | (x, y, z) for a 3D mesh or (x, y) for | component times the total |
| | a 2D mesh), concatenated in order. | number of vertex chains |
| | | from all the N_{patches} patches. |
| Vertex_Deltas | An array of vertex delta coordinates | Q_{d} bits per vertex delta |
| | (dx, dy, dz) for a 3D mesh or | position component times |
| | (dx, dy) for a 2D mesh, | the total number of vertices |
| | concatenated in order. | of all the patches minus the |
| | | total number of vertex |
| | | chains from all the N_{patches} |
| | | patches. |

Table 3 illustrates a variation of the signaling of the vertex chain symbol stream in which the symbols which describe the patches, vertex chains, and vertices of the overall mesh are arranged into a hierarchical nested descriptor.

TABLE 3
vertex chain symbol stream, arranged as a hierarchical nested descriptor

| | |
|---|---|
| partitioned_mesh_structure | |
| { | |
| num_patches; | Number of patches into which the overall |
| | mesh has been partitioned |
| for(i=0; i<num_patches; i++) | ** Patch Coding Loop ** |
| { | |
| num_vertex_chains[i]; | Number of vertex chains in a current patch i |
| for(j=0; j<num_vertex_chains; j++) | ** Vertex Chain Coding Loop ** |
| { | |
| position_of_vertex_chain[i][j]; | Symbol indicating position of current vertex |
| | chain relative to a reference vertex chain. |
| | Positive values indicate the current vertex |
| | chain is a number of levels above the |
| | reference chain. Negative values indicate |
| | the current vertex chain is below the |
| | reference chain. Zero indicates the current |
| | vertex chain is the reference chain. |
| num_vertices[i][j]; | Number of vertices in the current vertex |
| | chain |
| for(k=0; k<num_vertices; k++) | ** Vertices Coding Loop ** |
| { | |
| position_of_vertex[i][j][k]; | One or more symbols indicating position of |
| | the current vertex. These may indicate the |
| | absolute position of the current vertex, or |
| | may indicate the position relatively to that |
| | of one or more previously coded vertices. |
| } | ** End/Vertices Coding Loop ** |
| } | ** End/Vertex Chain Coding Loop ** |
| } | ** End/Patch Coding Loop ** |
| } | ** End/Partitioned Mesh Structure ** |

The vertex chain symbol stream 235, generated by the vertex chain encoder 230 (e.g., according to any of Table 1, Table 2, or Table 3), may be further encoded by the entropy encoder 240, generating a coded mesh 250. The stream's 235 portion that corresponds to structural data is typically encoded by a lossless encoder 242 (e.g., an encoder based on arithmetic, Huffman, or RLE coding techniques). For example, the stream 235 portion that corresponds to the number of patches in a given mesh 210 (Nb_Patches), the number of vertex chains in each patch (Nb_chains), the length of each of those vertex chains (Nb_vet), and the flags that indicate a depth (level) change of a chain (Depth_change) and the chain's position relative to a respective reference vertex chain (Relative_Position), typically, have to be encoded by the lossless encoder 242. While the stream's 235 portion that corresponds to the vertices' positions (Vertex_Positions and Vertex_Deltas) may be encoded by a lossy encoder 244. In an aspect, additional signaling may be added to indicate whether a lossless encoding or a lossy encoding had been applied to a respective portion of the vertex chain symbol stream. Following encoding, the coded mesh 250, provided by the entropy encoder 240, may be transmitted to a mesh topology decoder 300 for the latter to reconstruct the original mesh 210, as described further below.

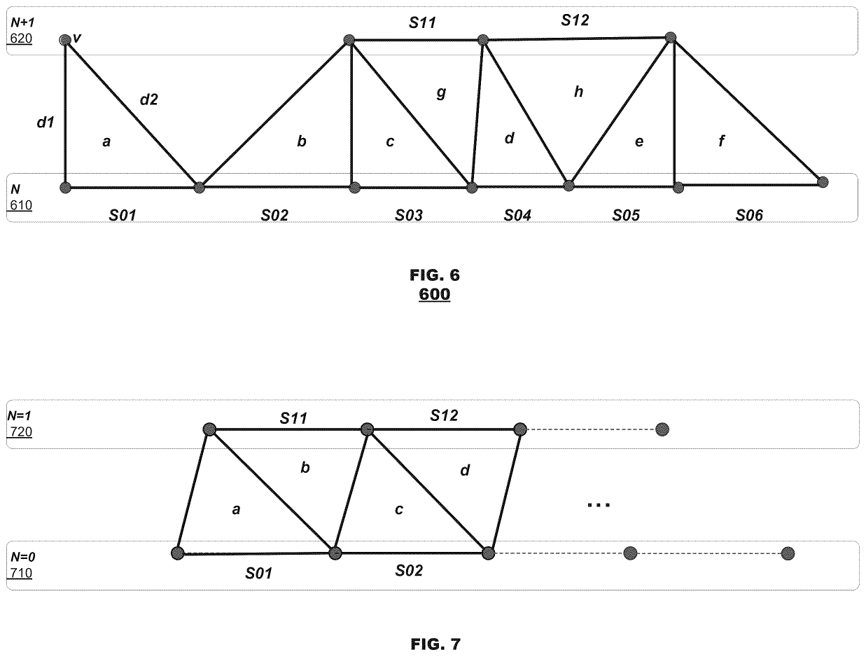

As mentioned above in reference to FIG. 3, the entropy decoder 320 receives the coded mesh 310 either from storage or directly via a communication link from the output of the encoder 250 (see FIG. 2). The entropy decoder 320 may recover the vertex chain symbol stream 325. Accordingly, a portion of that stream that was encoded by the lossless encoder 242 is decoded by the lossless decoder 322 and a portion of that stream that was encoded by the lossy encoder 244 is decoded by the lossy decoder 324. The decoded vertex chain symbol stream 325 may then be fed into the vertex chain decoder 330 that may be configured to reverse the operation of the vertex chain encoder 230, producing a decoded vertex chain data record 335. Note that in the case where delta coordinates were used to code some of the vertices' coordinates (e.g., using the Vertex_Deltas signaling of Table 2 or the relative position signaling option of Table 3) those vertices' coordinates are transformed back to global coordinates by vector additions (For example, the coordinates of vertex 14 are computed as P+d₁). The decoded vertex chain data record 335 may then be fed into the mesh topology generator 340. The mesh topology generator 340 may recover the mesh 210 (generating a reconstructed mesh 350), reconstructing the topology of each mesh patch based on its respective patch record in the decoded vertex chain data record 335. The reconstruction of a mesh patch topology may be carried out using a nearest point approach (as described in reference to FIG. 6) or a triangle strip (TriStrip) approach (as described in reference to FIG. 7).

FIG. 6 illustrates a reconstruction of an example mesh patch topology using a nearest point approach 600, according to an aspect of the present disclosure. Examining the vertex chains that are recorded in a patch record of a respective patch, the reconstruction of that patch's topology may include connecting vertices of vertex chains that are at levels that are either above (flagged by “T”) or below (flagged by “B”) the reference vertex chain of the patch. For example, reconstruction of the topology of a mesh patch may involve connecting vertices in vertex chains at a level N 610 with vertices in vertex chains at a level N+1 620. FIG. 6 illustrates the process of connecting vertices in two steps. In the first step, for each segment that connects two successive vertices in a vertex chain at level N 610 (one of segments S01-S06) a triangle is formed by connecting the vertices that delineate the segment to the nearest vertex among vertices in the vertex chains at level N+1 620 (respective triangles a-f). For example, with respect to segment S01, triangle a is formed by the nearest vertex v (when the sum of Euclidian distances, d1 and d2, is found to be minimal). Then, in a second step, the same operation is performed for segments of vertex chains at level N+1 620 that were connected to vertices of chains at level N 610 in the first step. For example, triangle g and h, associated with segments S11 and S12, respectively, are formed in the second step. Note that in both steps, a vertex chain that consists of only one vertex has no segments, and, thus, no triangles can be formed with respect to such a chain (however, the one vertex may be connected to a segment from another chain, as shown with respect to vertex v that forms triangle a with segment S01).

FIG. 7 illustrates a reconstruction of an example mesh patch topology using a triangle strip approach 700, according to an aspect of the present disclosure. An alternative approach for reconstructing the topology of a mesh patch (which does not rely on computing nearest vertices) may be used when the number of vertices in the vertex chain(s) at each level N 710 is the same as (or similar to) the number of vertices in the vertex chain(s) at the neighboring level N+1 720. The steps in this approach are as follows. The processing begins with respect to the reference vertex chain at level N=0 and vertex chain(s) at level N=1, processing vertex chain(s) at level N=1 that are either on the top or on the bottom of level N=0. Hence, for the first segment S01 in the reference vertex chain, a triangle a is formed using the two vertices that delineate S01 and the first vertex of the first segment S11 at level N=1. Next, a second triangle b is formed between the vertices that delineate segment S11 at level N=1 and the vertex that ends segment S01. Similarly, the third triangle c is formed between the vertices that delineate segment S02 at level N=0 and the vertex that ends segment S11 at level N=1. This process may be continued until there are no more vertices left to process at level N=0 or level N=1 on the processed side (e.g., top). The process is repeated for the vertex chain(s) at levels N=0 and N=1 on the opposite side (e.g., bottom). Vertex chains of successive levels (N=1 and N=2, N=2 and N=3, etc.) are similarly processed to reconstruct the entire mesh patch topology.

Once the mesh patches are reconstructed, as described with respect to FIG. 6 and to FIG. 7, the mesh topology generator 340 may reconstruct the full mesh 350 by combining (i.e., stitching) together the reconstructed patches. In an aspect, combining the reconstructed patches may include spatially filtering the patches to spatially blend their interfacing boundaries, as well as correcting for overlaps or gaps among neighboring patches.

The reconstruction of the original mesh topology, as described herein, is a lossy process—that is, the reconstructed mesh surface 350 may not be the same as the original one 210. This may be the case even if vertex positions are encoded in a lossless manner, as the processes described with respect to FIG. 6 and FIG. 7 may not result in the same connections among the patches' vertices (or the same triangles) as those in the respective original patches. However, as mentioned above, the reconstructed mesh surface 350 may be perceptively the same as the original mesh surface 210, and so may not compromise viewers' experience, especially for applications in the entertainment domain. At the same time, encoding a general mesh topology by partitioning it into smaller and spatially simpler patches (mesh patches that are homeomorphic to a disk), as described herein, leads to a higher compression rate compared to approaches that code the full mesh topology.

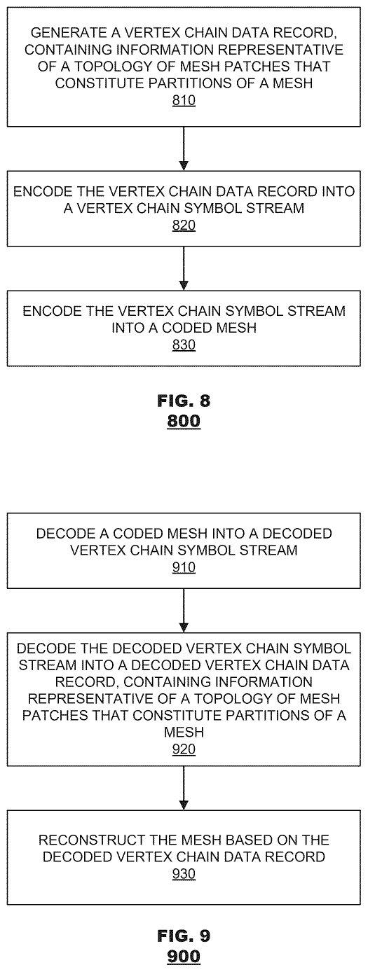

FIG. 8 is a flow diagram of an example method for encoding a mesh topology 800, according to an aspect of the present disclosure. The method 800 may be performed by the mesh topology encoder 200, described in reference to FIG. 2. The method 800 begins, in step 810, by generating a vertex chain data record 225. The vertex chain data record may contain information representative of a topology of mesh patches that constitute partitions of the mesh to be encoded. In step 820, the generated vertex chain data record may be encoded into a vertex chain symbol stream 235. Then, in step 830, the vertex chain symbol stream may be further encoded into a coded mesh 250. As described in reference to FIG. 4 and to FIG. 5, generating the vertex chain data record 225 comprises, for each mesh patch, deriving vertex chains, including: determining a reference vertex chain from the mesh patch and then determining additional vertex chains from the mesh patch relative to the reference vertex chain. Each chain of the additional vertex chains may include vertices that are separated by the same number of mesh edges from a respective closest vertex from the reference vertex chain, where the chain is associated with a level value, indicating the number of mesh edges. Furthermore, each chain of the additional vertex chains is associated with a relative position indicator, indicating whether the chain is positioned above or below the reference vertex chain.

Based on the signaling examples described in reference to Table 1, Table 2, and Table 3, in step 820, the encoding of the generated vertex chain data record 225 into the vertex chain symbol stream 235 comprises: 1) signaling the number of the mesh patches; 2) for each of the mesh patches, signaling the number of the derived vertex chains in the mesh patch; then, for each of the vertex chains, derived for each of the mesh patches, 3) signaling the number of vertices in the vertex chain; 4) signaling the depth change; 5) signaling the relative position; and 6) signaling global coordinates of vertices of the vertex chain (e.g., according to Table 1 and/or using the absolute position signaling option of Table 3) or signaling global and delta coordinates of vertices of the vertex chain (e.g., according to Table 2 and/or using the relative position signaling option of Table 3).

FIG. 9 is a flow diagram of an example method for reconstructing a mesh topology 900, according to an aspect of the present disclosure. The method 900 may be performed by the mesh topology decoder 300, described in reference to FIG. 3. The method 900 begins, in step 910, by decoding a coded mesh 310 into a decoded vertex chain symbol stream 325. In step 920, the decoded vertex chain symbol stream 325 may be decoded into a decoded vertex chain data record 335. The decoded vertex chain data record 335 may contain information representative of a topology of mesh patches that constitute partitions of the mesh 210 to be reconstructed 350. Then, in step 930, based on the decoded vertex chain data record, the mesh may be reconstructed, generating a reconstructed mesh. As described in reference to FIG. 4 and to FIG. 5, the decoded vertex chain data record 335 may comprise, for each mesh patch of the mesh patches, vertex chains including a reference vertex chain and additional vertex chains that are positioned relative to the reference vertex chain, where each of the vertex chains links one or more vertices of the mesh patch. Each chain of the additional vertex chains may include vertices that may be separated by the same number of mesh edges from a respective closest vertex from the reference vertex chain, where the chain is associated with a level value, indicating the number of mesh edges. Furthermore, each chain of the other vertex chains is associated with a relative position indicator, indicating whether the chain is positioned above or below the reference vertex chain.

Based on the signaling examples described in reference to Table 1, Table 2, and Table 3, in step 920, the decoding of the decoded vertex chain symbol stream 325 may comprise decoding the number of the mesh patches, and, for each of the mesh patches, decoding the number of the vertex chains in the mesh patch. Next, for each of the vertex chains, of each of the mesh patches, the number of vertices in the vertex chain, the position information of the vertex chain (e.g., depth change and relative position) are decoded. Following this is the decoding of the vertex positions, whether according to global coordinates of the vertices in the vertex chain (e.g., according to Table 1), according to a global coordinate of the first vertex in the vertex chain and then delta coordinates of the remaining vertices in the vertex chain (e.g., according to Table 2), or according to a more general mixture of symbols representing absolute and relative vertex positions (e.g., using the absolute and relative position options of Table 3).

The illustrations of the aspects described herein are intended to provide a general understanding of the structure, function, and operation of the various aspects. The illustrations are not intended to serve as a complete description of all of the elements and features of apparatuses and systems that utilize the structures or methods described herein. Many other aspects may be apparent to those of skill in the art upon reviewing the disclosure. Other aspects may be utilized and derived from the disclosure, such that structural and logical substitutions and changes may be made without departing from the scope of the disclosure. Accordingly, the disclosure and the figures are to be regarded as illustrative rather than restrictive.

The description of the aspects is provided to enable the making or use of the aspects. Various modifications to these aspects will be readily apparent, and the generic principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

1. A method for encoding a mesh topology, comprising:
generating a vertex chain data record, containing information representative of a topology of mesh patches that constitute partitions of a mesh;
encoding the generated vertex chain data record into a vertex chain symbol stream; and
encoding the vertex chain symbol stream into a coded mesh.

2. The method according to claim 1, wherein the generating of the vertex chain data record comprises:
for each mesh patch of the mesh patches, deriving vertex chains, including:
determining a reference vertex chain from the mesh patch; and
determining additional vertex chains from the mesh patch relative to the reference vertex chain,
wherein each of the derived vertex chains links one or more vertices of the mesh patch.

3. The method according to claim 1, wherein each chain of the additional vertex chains includes vertices that are separated by the same number of mesh edges from a respective closest vertex from the reference vertex chain, and wherein the chain is associated with a level value, indicating the number of mesh edges.

4. The method according to claim 1, wherein each chain of the additional vertex chains is associated with a relative position indicator, indicating whether the chain is positioned above or below the reference vertex chain.

5. The method according to claim 1, wherein the encoding of the generated vertex chain data record into the vertex chain symbol stream comprises:
signaling a number of the mesh patches.

6. The method according to claim 1, wherein the encoding of the generated vertex chain data record into the vertex chain symbol stream comprises:
for each of the mesh patches, signaling a number of the vertex chains in the mesh patch.

7. The method according to claim 1, wherein the encoding of the generated vertex chain data record into the vertex chain symbol stream comprises:
for each of the vertex chains derived for each of the mesh patches, signaling a number of vertices in the vertex chain.

8. The method according to claim 1, wherein the encoding of the generated vertex chain data record into the vertex chain symbol stream comprises:
for each of the vertex chains derived for each of the mesh patches, signaling a depth change, indicating a change in the level value associated with the vertex chain.

9. The method according to claim 1, wherein the encoding of the generated vertex chain data record into the vertex chain symbol stream comprises:
for each of the vertex chains derived for each of the mesh patches, signaling a relative position, indicating the relative position indicator associated with the vertex chain.

10. The method according to claim 1, wherein the encoding of the generated vertex chain data record into the vertex chain symbol stream comprises:
for each of the vertex chains derived for each of the mesh patches, signaling vertices of the vertex chain, including signaling of global coordinates of the vertices, delta coordinates of the vertices, or a combination thereof.

11. A method for reconstructing a mesh topology, comprising:
decoding a coded mesh into a decoded vertex chain symbol stream;
decoding the decoded vertex chain symbol stream into a decoded vertex chain data record, containing information representative of a topology of mesh patches that constitute partitions of a mesh; and
reconstructing the mesh based on the decoded vertex chain data record.

12. The method according to claim 11, wherein the decoded vertex chain data record comprises, for each mesh patch of the mesh patches, vertex chains, including a reference vertex chain and additional vertex chains that are positioned relative to the reference vertex chain, wherein each of the vertex chains links one or more vertices of the mesh patch.

13. The method according to claim 11, wherein each chain of the additional vertex chains includes vertices that are separated by the same number of mesh edges from a respective closest vertex from the reference vertex chain, and wherein the chain is associated with a level value, indicating the number of mesh edges.

14. The method according to claim 11, wherein each chain of the additional vertex chains is associated with a relative position indicator, indicating whether the chain is positioned above or below the reference vertex chain.

15. The method according to claim 11, wherein the decoding of the decoded vertex chain symbol stream comprises:
decoding a number of the mesh patches.

16. The method according to claim 11, wherein the decoding of the decoded vertex chain symbol stream comprises:
for each of the mesh patches, decoding a number of the vertex chains in the mesh patch.

17. The method according to claim 11, wherein the decoding of the decoded vertex chain symbol stream comprises:
for each of the vertex chains, of each of the mesh patches, decoding a number of vertices in the vertex chain.

18. The method according to claim 11, wherein the decoding of the decoded vertex chain symbol stream comprises:
for each of the vertex chains, of each of the mesh patches, decoding a depth change, indicating a change in the level value associated with the vertex chain.

19. The method according to claim 11, wherein the decoding of the decoded vertex chain symbol stream comprises:
for each of the vertex chains, of each of the mesh patches, decoding a relative position, indicating the relative position indicator associated with the vertex chain.

20. The method according to claim 11, wherein the decoding of the decoded vertex chain symbol stream comprises:
for each of the vertex chains, of each of the mesh patches, decoding vertices of the vertex chain, including global coordinates of the vertices, delta coordinates of the vertices, or a combination thereof.

21. The method according to claim 11, wherein the reconstructing of the mesh comprises:
for each of the mesh patches, connecting vertices of vertex chains of a mesh patch from the vertex chain data record to obtain the topology of the mesh patch, the connecting forms triangles using respective segments of vertex chains, wherein a segment connects two successive vertices of a vertex chain.

22. The method according to claim 21, wherein the connecting further comprises connecting a segment from a vertex chain to the closest vertex from a neighboring vertex chain to form a triangle.

23. The method according to claim 21, wherein the connecting further comprises connecting a first segment from a first vertex chain with a second segment from a second vertex chain, forming a first triangle based on the first segment and a first vertex of the second segment and forming a second triangle based on the second segment and a second vertex of the first segment.

24. An apparatus for encoding a mesh topology, comprising:
at least one processor; and
memory storing instructions that, when executed by the at least one processor, cause the apparatus to:
generate a vertex chain data record, containing information representative of a topology of mesh patches that constitute partitions of a mesh;
encode the generated vertex chain data record into a vertex chain symbol stream; and
encode the vertex chain symbol stream into a coded mesh.

25. The apparatus according to claim 24, wherein the generating of the vertex chain data record comprises:
for each mesh patch of the mesh patches, deriving vertex chains, including:
determining a reference vertex chain from the mesh patch; and
determining additional vertex chains from the mesh patch relative to the reference vertex chain,
wherein each of the derived vertex chains links one or more vertices of the mesh patch.

26. The apparatus according to claim 24, wherein each chain of the additional vertex chains includes vertices that are separated by the same number of mesh edges from a respective closest vertex from the reference vertex chain, and wherein the chain is associated with a level value, indicating the number of mesh edges.

27. The apparatus according to claim 24, wherein each chain of the additional vertex chains is associated with a relative position indicator, indicating whether the chain is positioned above or below the reference vertex chain.

28. An apparatus for reconstructing a mesh topology, comprising:
at least one processor; and
memory storing instructions that, when executed by the at least one processor, cause the apparatus to:
decode a coded mesh into a decoded vertex chain symbol stream;
decode the decoded vertex chain symbol stream into a decoded vertex chain data record, containing information representative of a topology of mesh patches that constitute partitions of a mesh; and
reconstruct the mesh based on the decoded vertex chain data record.

29. The apparatus according to claim 28, wherein the reconstructing of the mesh comprises:
for each of the mesh patches, connecting vertices of vertex chains of a mesh patch from the vertex chain data record to obtain the topology of the mesh patch, the connecting forms triangles using respective segments of vertex chains, wherein a segment connects two successive vertices of a vertex chain.

30. The apparatus according to claim 29, wherein the connecting further comprises connecting a segment from a vertex chain to the closest vertex from a neighboring vertex chain to form a triangle.

31. The apparatus according to claim 29, wherein the connecting further comprises connecting a first segment from a first vertex chain with a second segment from a second vertex chain, forming a first triangle based on the first segment and a first vertex of the second segment and forming a second triangle based on the second segment and a second vertex of the first segment.

32. A non-transitory computer-readable medium comprising instructions executable by at least one processor to perform a method for encoding a mesh topology, the method comprising:
generating a vertex chain data record, containing information representative of a topology of mesh patches that constitute partitions of a mesh;
encoding the generated vertex chain data record into a vertex chain symbol stream; and
encoding the vertex chain symbol stream into a coded mesh.

33. A non-transitory computer-readable medium comprising instructions executable by at least one processor to perform a method for reconstructing a mesh topology, the method comprising:
decoding a coded mesh into a decoded vertex chain symbol stream;
decoding the decoded vertex chain symbol stream into a decoded vertex chain data record, containing information representative of a topology of mesh patches that constitute partitions of a mesh; and
reconstructing the mesh based on the decoded vertex chain data record.
